(19) United States
(12) Patent Application Publication
(10) Pub. No.: US 2026/0241779 A1
(43) Pub. Date: Aug. 20, 2026

(54) DOOR ARCHITECTURE FOR A MOTOR VEHICLE

(71) Applicant: MAGNA INTERNATIONAL INC., Aurora (CA)

(72) Inventors: Cangji SHI, Oakland Township, MI (US); Rahul JOSHI, Rochester Hills, MI (US); Johannes SAUERZAPF, Traiskirchen (AT)

(21) Appl. No.: 19/537,912

(22) Filed: Feb. 12, 2026

Related U.S. Application Data
(60) Provisional application No. 63/760,256, filed on Feb. 19, 2025.

(51) Int. Cl. B60J 5/04

(52) U.S. Cl. CPC B60J 5/0402; B60J 5/0405

(57) ABSTRACT

A door assembly for a vehicle includes: a door inner base defining a door structure and a window frame; and a door outer cover fixed to the door inner base below the window frame. The door inner base is formed from one of: a one-piece aluminum casting, or a steel stamping with a plurality of steel patch inner reinforcements. Another door assembly for a vehicle includes: a door inner base defining a door structure; a reinforcement member attached to the door inner base; and a door outer cover made of plastic and fixed to the door inner base. The door inner base is formed from one of: a one-piece aluminum casting, or a steel stamping with a plurality of steel patch inner reinforcements. A method of manufacturing a door assembly for a vehicle is also provided.

### CROSS REFERENCE TO RELATED APPLICATIONS

This utility patent application claims the benefit of U.S. Provisional Patent Application No. 63/760,256 filed Feb. 19, 2025, the contents of which is incorporated herein by reference in its entirety.

### FIELD

The present disclosure relates generally to construction of doors for motor vehicles.

### BACKGROUND

Vehicle manufacturers, also called original equipment manufacturers (OEMs) are facing increased cost pressure and low profitability due to higher requirements and variability of customer demands. To address these pressures, vehicle manufacturers desire low-cost integrated system solutions addressing bill-of-materials (BOM) and manufacturing, tooling costs, and capital investment. Traditional door-in-white architectures for doors of passenger vehicles, such as cars and trucks, include multi-piece stampings, which have relatively high part count and high capital, tooling and manufacturing costs.

### SUMMARY

The present disclosure provides a door assembly for a vehicle. The door assembly includes: a door inner base defining a door structure and a window frame; and a door outer cover fixed to the door inner base below the window frame. The door inner base is formed from one of: a one-piece aluminum casting, or a steel stamping with a plurality of steel patch inner reinforcements.

The present disclosure also provides a door assembly for a vehicle, which includes: a door inner base defining a door structure; a reinforcement member attached to the door inner base; and a door outer cover made of plastic and fixed to the door inner base. The door inner base is formed from one of: a one-piece aluminum casting, or a steel stamping with a plurality of steel patch reinforcements.

The present disclosure also provides a method of manufacturing a door assembly for a vehicle. The method includes: forming a door inner base from an aluminum casting or a steel patch stamping; attaching a plurality of reinforcement members to the door inner base to define a door inner assembly; treating the door inner assembly with a powder coating process or combined with other corrosion protection coating process; and attaching a color painted door outer cover to the door inner assembly after the powder coating process.

These and other aspects of the present disclosure are disclosed in the following detailed description of the embodiments, the appended claims, and the accompanying figures.

### BRIEF DESCRIPTION OF THE DRAWINGS

Further details, features and advantages of designs of the invention result from the following description of embodiment examples in reference to the associated drawings, in which a battery frame is disclosed.

FIG. 1 shows a diagram illustrating steps in manufacturing a door assembly for a motor vehicle using traditional construction techniques.

FIG. 2 shows a diagram illustrating steps in manufacturing a first door assembly with a first construction technique, in accordance with an aspect of the disclosure.

FIG. 3 shows a diagram illustrating steps in manufacturing a second door assembly with a second construction technique, in accordance with an aspect of the disclosure.

FIG. 4 shows a diagram illustrating steps in manufacturing and assembling a door assembly with an exterior mirror assembly, using traditional construction techniques.

FIG. 5 shows a diagram illustrating steps in manufacturing and assembling a door assembly with an integrated mirror flag for an exterior mirror assembly, in accordance with an aspect of the disclosure.

FIG. 6 shows a flow chart of steps in a method of manufacturing a door assembly for a vehicle, in accordance with some embodiments of the present disclosure.

### DETAILED DESCRIPTION

Recurring features are marked with identical reference numerals in the figures, in which example embodiments are disclosed. The present disclosure provides construction details and architectures for manufacturing doors for a motor vehicle, such as a passenger car or truck.

Objectives of the present disclosure include providing a highly integrated, offline painted door concept that allows full assembly of all components allowing just a one-time installation to the painted vehicle. The present disclosure also provides alternative Door-in-White architectures for cost reduction compared to traditional build with multi-piece stampings. The alternative door architectures of present disclosure include: a 1-piece cast Al door inner with a plastic door outer, and a multi-piece door inner having a steel patch construction and with plastic door outer. The present disclosure also provides a door architecture with a mirror flag integrated into the door structure to enable quick connection to an exterior mirror, and which includes anti-theft features.

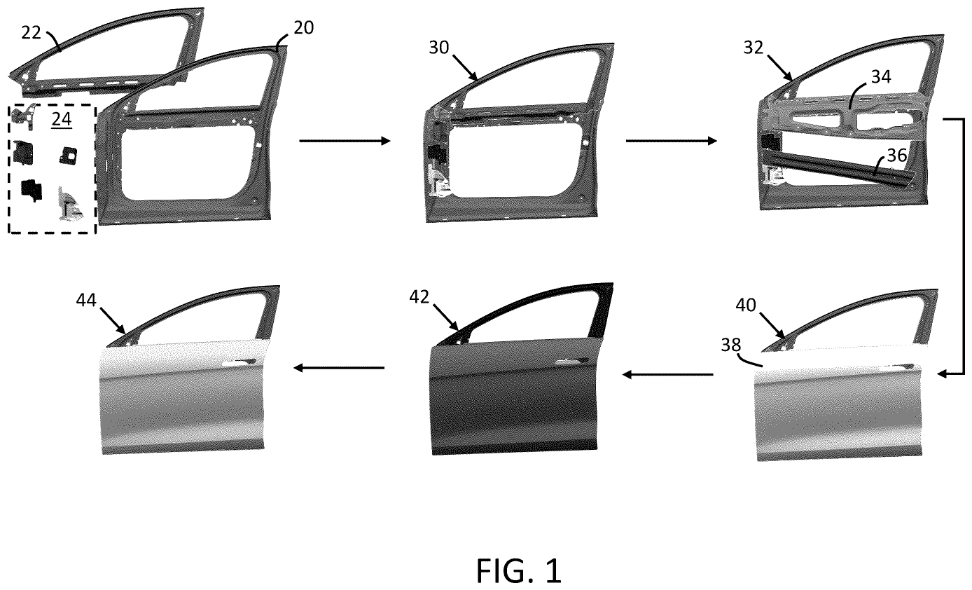

FIG. 1 shows a diagram illustrating steps in manufacturing a door assembly for a motor vehicle using traditional construction techniques. A door inner stamping 20 is attached to an inner window reinforcement 22 of stamped steel/aluminum. Several additional fittings 24, such as hinges latches and support plates, are attached to the door inner stamping 20 to define a door inner sub-assembly 30. Additional reinforcement members 34, 36, such as stamped belt reinforcement and door beam, are welded or otherwise attached to the door inner sub-assembly 30 to define a door inner assembly 32. A door outer panel 38 is attached to the door inner assembly 32 to define a door-in-white (DIW) 40. The DIW 40 is treated with an electrodeposition (e-coat) process to define an e-coated door 40, which is subsequently painted with one or more color and/or clearcoat layers to provide a painted door 42.

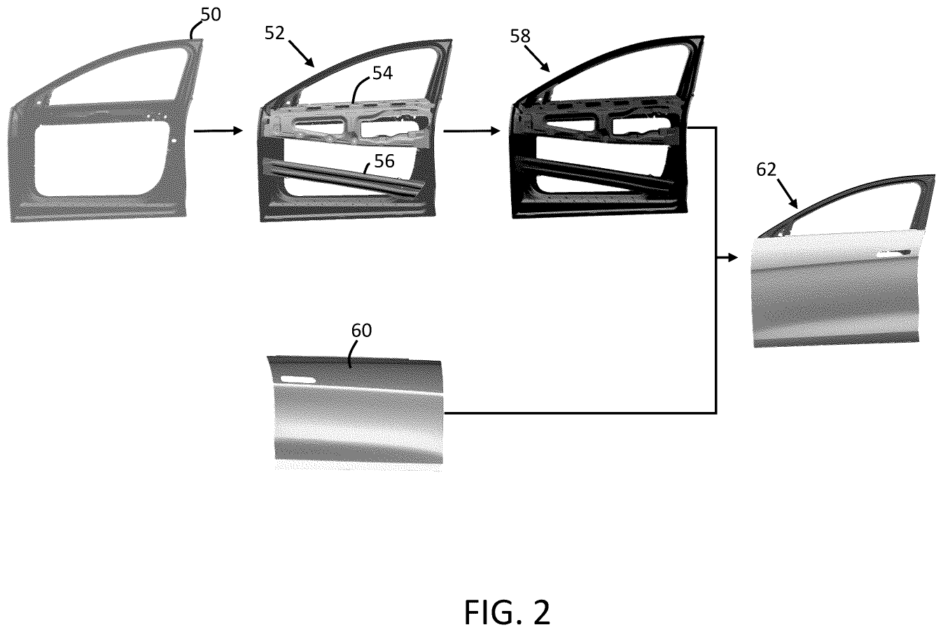

FIG. 2 shows a diagram illustrating steps in manufacturing a first door assembly 62 with a first construction technique of the present disclosure. A first door inner base 50 is formed from a one-piece aluminum casting that defines a door structure including a window frame. The one-piece aluminum casting may be made of 100% aluminum metal or an alloy containing a substantial majority composition of aluminum with one or more additives, such as copper, magnesium, silicon, zinc, and/or manganese. Reinforcement members 54, 56, such as stamped aluminum belt reinforcement and steel door beam, are attached to the first door inner base 50 to define a first door inner assembly 52. The first door inner assembly 52 is treated with a powder coating process to define a first powder coated door inner assembly 58. A color painted door outer cover 60 of plastic is fixed to the door inner base of the first powder coated door inner assembly 58, below the window frame, to define the first door assembly 62.

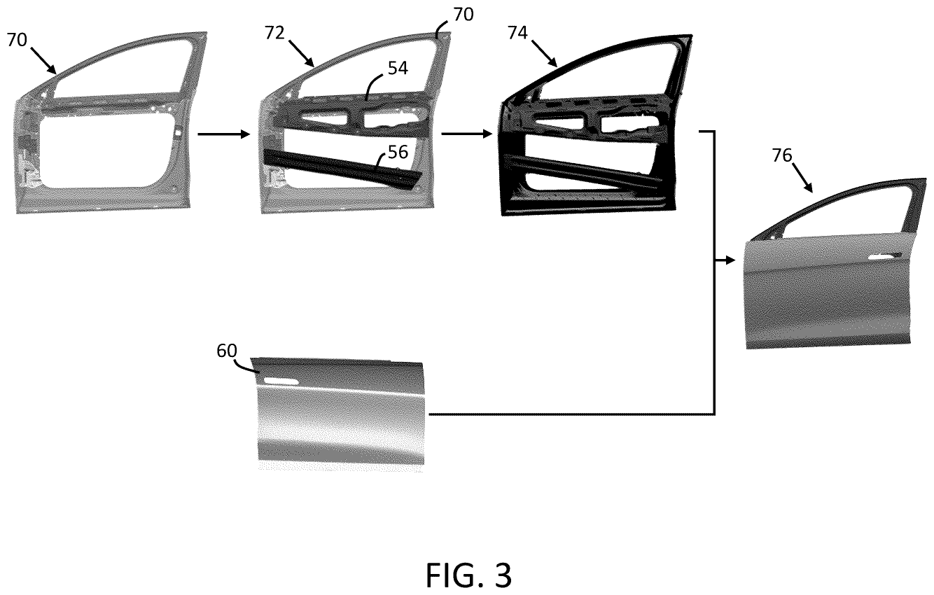

FIG. 3 shows a diagram illustrating steps in manufacturing a second door assembly 76 with a second construction technique of the present disclosure. A second door inner base 70 includes a one-piece steel stamping with local patch reinforcements, which may be made of steel. Reinforcement members 54, 56, such as stamped steel belt reinforcement and door beam, are attached to the second door inner base 70 to define a second door inner assembly 72. The second door inner assembly 72 is treated with a primer or electrocoating and powder coating process to define a coated door inner assembly 74. A color painted door outer cover 60 of plastic is fixed to the coated door inner assembly 74, below the window frame, to define the second door assembly 76.

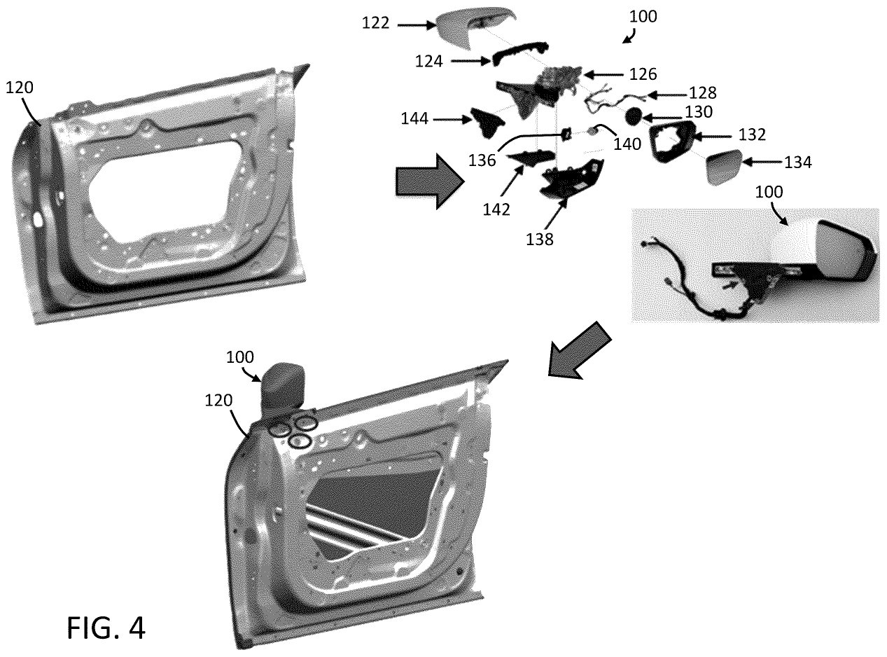

FIG. 4 shows a diagram illustrating steps in manufacturing and assembling a door assembly with a first exterior mirror assembly 100, using traditional construction techniques. The first exterior mirror assembly 100 is attached to a stamped door inner 120 of stamped steel. The first exterior mirror assembly 100 includes a mirror upper cover 122 attached to a turn signal light 124 and a mirror frame 126. The first exterior mirror assembly 100 also includes a wire harness 128, a motor 130, a mirror mounting 132, a mirror glass 134, a bracket 136, and a bottom cover 138 with a camera 140 disposed therein.

The mirror frame 126 has an integrated mirror flag that spaces the mirror upper cover 122 away from the stamped door inner 120. A mirror flag cover 142 covers the integrated mirror flag portion of the mirror frame 126 and defines an exterior class-A surface of the vehicle.

A noise, vibration, and harshness (NVH) pad 144 of resilient material, such as rubber or foam, is disposed between the mirror frame 126 and the stamped door inner 120 to prevent generation and/or transmission of vibration. The first exterior mirror assembly 100 is attached to the stamped door inner 120 using a set of screws in a manual process during door assembly.

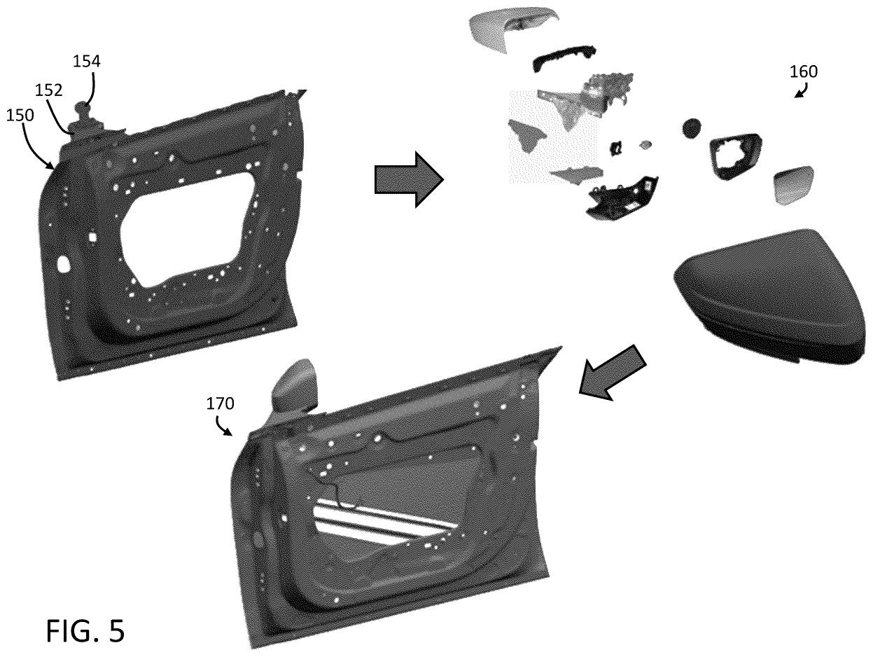

FIG. 5 shows a diagram illustrating steps in manufacturing and assembling a third door assembly 170 of the present disclosure, and which has an integrated mirror flag for an exterior mirror assembly. A third door inner base 150 is formed from cast Aluminum and includes an integrated mirror flag 152 configured to support an exterior mirror assembly. The integrated mirror flag 152 also includes a quick connect retainer 154 for attaching the exterior mirror assembly without the use of tools. In some embodiments, and as shown on FIG. 5, the quick connect retainer 154 includes a ball that is configured to be retained by a socket of the exterior mirror assembly. However, the quick connect retainer 154 may have an opposite configuration, such as a socket configured to receive a ball of the exterior mirror assembly. The quick connect retainer 154 may have a different configuration altogether, such as a latching retainer.

FIG. 5 also shows a second exterior mirror assembly 160 for attachment to the third door assembly 170. The second exterior mirror assembly 160 may be similar or identical to the first exterior mirror assembly 100, except without the mirror flag, the NVH pad 144, and the mirror flag cover 142.

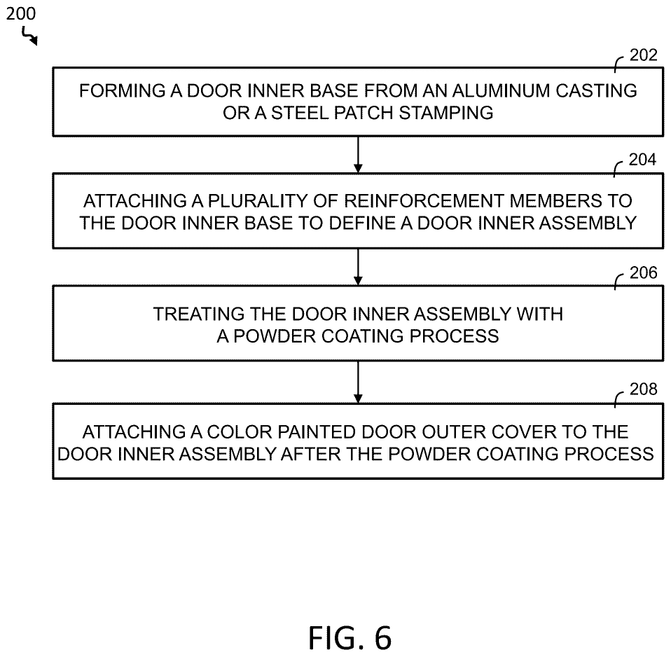

A method 200 of manufacturing a door assembly for a vehicle is shown in the flow chart of FIG. 6. As can be appreciated in light of the disclosure, the order of operation within the method is not limited to the sequential execution as illustrated in FIG. 6, but may be performed in one or more varying orders as applicable and in accordance with the present disclosure.

The method 200 includes forming a door inner base from an Aluminum casting or a steel patch stamping, at step 202. In some embodiments, step 202 further includes attaching a plurality of steel or aluminum reinforcements to the door inner base. In some embodiments, step 202 further includes forming the aluminum casting or steel patch stamping with an integrated mirror flag configured to support an exterior mirror assembly.

The method 200 also includes attaching a plurality of reinforcement members to the door inner base to define a door inner assembly, at step 204.

The method 200 also includes treating the door inner assembly with a powder coating process, at step 206.

The method 200 also includes attaching a color painted door outer cover to the door inner assembly after the powder coating process, at step 208.

In one aspect, the present disclosure provides a door assembly having a door inner base made of cast Aluminum (Al) and with a door outer made of plastic. This cast Al door inner+plastic door outer assembly includes several features, including:
Functional integration with 1-pc Al casting door inner;
Cast Al door inner, reduced part count & assembly cost;
Recycled Al alloy can be an option to reduce CO2 emissions footprint;
Black/neutral powder coating, acrylic coating, or other coating/painting of door inner assembly;
Color painted plastic outer panel;
Outer panel is attached to door inner, for example using adhesive or bolts; and
Door outer panel cannot be removed, serviceability is realized by door module carrier.

In another aspect, the present disclosure provides a door assembly having a door inner base with a stamped steel patch construction, and with a door outer made of plastic. This steel patch door inner+plastic door outer assembly includes several features, including:
Low-cost steel patch inner with integrated inner reinforcements;
Patch welded door inner, reduced stamping die/fixture/assembly costs;
Black/neutral powder coating, acrylic coating or other coating/painting of door inner assembly;
Color painted plastic outer panel;
Outer panel is attached to door inner using bolts, clips or adhesive; and
Door outer panel cannot be removed, serviceability is realized by door module carrier.

In another aspect, the present disclosure provides a door assembly with an integrated mirror flag. The integrated mirror flag may include a mirror flag being integrated in an Aluminum casting of the inner base. The integrated mirror flag may include quick connect and/or anti-theft feature. The integrated mirror flag may provide for snap-in attachment of an exterior rear-view mirror assembly, for ease of assembly.

The present disclosure provides a door assembly for a vehicle. The door assembly includes: a door inner base defining a door structure and a window frame; and a door outer cover fixed to the door inner base below the window frame. The door inner base is formed from one of: a one-piece aluminum casting, or a steel stamping with a plurality of steel patch inner reinforcements.

In some embodiments, the door inner base is formed from the steel stamping with the plurality of steel patch inner reinforcements, and the plurality of steel patch inner reinforcements include a steel reinforcement around the window frame

In some embodiments, the door inner base is formed from a one-piece aluminum casting.

In some embodiments, the door assembly further includes a plurality of reinforcement members attached to the door inner base.

In some embodiments, the door inner base further includes an integrated mirror flag of cast aluminum extending outward perpendicularly to the window opening, and wherein the integrated mirror flag is configured to support an exterior mirror assembly.

In some embodiments, the integrated mirror flag defines a quick connect retainer for attaching the exterior mirror assembly without the use of tools.

In some embodiments, the quick connect retainer includes a ball configured to be retained by a socket of the exterior mirror assembly.

In some embodiments, the integrated mirror flag defines an anti-theft feature to prevent the exterior mirror assembly from being detached therefrom without the use of a specialized tool. For example, the integrated mirror flag may include a catch or other structure that prevents the exterior mirror assembly from being detached from the integrated mirror flag. The catch or other structure may be recessed or otherwise blocked from being actuated without the use of specialized tools. Alternatively or additionally, the catch or other structure not be accessible from an exterior of the door or without disassembling the door assembly.

In some embodiments, the door outer cover is made of plastic. However, the door outer cover may be made of metal, a composite material, or from two or more pieces of different materials.

In some embodiments, the door outer cover is fixed to the door inner base using a non-serviceable attachment. For example, the door outer cover may be fixed to the door inner base using an adhesive and/or material deformation (e.g. ultrasonic welding), or clips. The door outer cover may not be removable by non-destructive means. Serviceability may be only possible from an interior side of the door assembly, such as through a door module carrier

The present disclosure also provides another door assembly for a vehicle, which comprises: a door inner base defining a door structure; a reinforcement member attached to the door inner base; and a door outer cover made of plastic and fixed to the door inner base. The door inner base is formed from one of: a one-piece Aluminum casting, or an Aluminum casting with a steel patch inner reinforcement.

In some embodiments, the door inner base is formed from the steel stamping with the plurality of steel patch inner reinforcements, and the plurality of Steel patch inner reinforcements include a steel reinforcement around a window frame thereof.

In some embodiments, the door inner base is formed from a one-piece aluminum casting.

In some embodiments, the door inner base further includes an integrated mirror flag of cast Aluminum, and wherein the integrated mirror flag is configured to support an exterior mirror assembly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A door assembly for a vehicle, comprising:
a door inner base defining a door structure and a window frame; and
a door outer cover fixed to the door inner base below the window frame,
wherein the door inner base is formed from one of: a one-piece aluminum casting, or a steel stamping with a plurality of steel patch inner reinforcements.

2. The door assembly of claim 1, wherein the door inner base is formed from the steel stamping with the plurality of steel patch inner reinforcements, and wherein the plurality of steel patch inner reinforcements include a steel reinforcement around the window frame.

3. The door assembly of claim 1, wherein the door inner base is formed from a one-piece aluminum casting.

4. The door assembly of claim 1, further including a reinforcement member attached to the door inner base.

5. The door assembly of claim 1, the door inner base further includes an integrated mirror flag of cast aluminum extending outward perpendicularly to the window opening, and wherein the integrated mirror flag is configured to support an exterior mirror assembly.

6. The door assembly of claim 5, wherein the integrated mirror flag defines a quick connect retainer for attaching the exterior mirror assembly without use of tools.

7. The door assembly of claim 6, wherein the quick connect retainer includes a ball configured to be retained by a socket of the exterior mirror assembly.

8. The door assembly of claim 5, wherein the integrated mirror flag defines an anti-theft feature to prevent the exterior mirror assembly from being detached therefrom without use of a specialized tool.

9. The door assembly of claim 1, wherein the door outer cover is made of plastic.

10. The door assembly of claim 1, wherein the door outer cover is fixed to the door inner base using a non-serviceable attachment.

11. A door assembly for a vehicle, comprising:
a door inner base defining a door structure;
a reinforcement member attached to the door inner base; and
a door outer cover made of plastic and fixed to the door inner base,
wherein the door inner base is formed from one of: a one-piece aluminum casting, or a steel stamping with a plurality of steel patch inner reinforcements.

12. The door assembly of claim 11, wherein the door inner base is formed from the steel stamping with the plurality of steel patch inner reinforcements, and wherein the plurality of steel patch inner reinforcements include a steel reinforcement around a window frame thereof.

13. The door assembly of claim 11, wherein the door inner base is formed from a one-piece aluminum casting.

14. The door assembly of claim 11, the door inner base further includes an integrated mirror flag of cast aluminum, and wherein the integrated mirror flag is configured to support an exterior mirror assembly.

15. A method of manufacturing a door assembly for a vehicle, the method comprising:
forming a door inner base from an aluminum casting;
attaching a reinforcement member to the door inner base to define a door inner assembly;
treating the door inner assembly with a powder coating process; and
attaching a color painted door outer cover to the door inner assembly after the powder coating process.

16. The method of claim 15, wherein forming the door inner base further includes casting the door inner base from the Aluminum casting and as one-piece Aluminum casting.

17. The method of claim 15, wherein forming the door inner base further includes forming the Aluminum casting with an integrated mirror flag configured to support an exterior mirror assembly.
